(19) United States
(12) Patent Application Publication
(10) Pub. No.: US 2006/0265487 A1
(43) Pub. Date: Nov. 23, 2006

(54) Apparatus, Method, and Computer Program Product For Communication Channel Verification

(75) Inventor: Michael E. Woods, Tiburon, CA (US)

Correspondence Address: MICHAEL E. WOODS;PATENT LAW OFFICES OF MICHAEL E. WOODS, 112 BARN ROAD, TIBURON, CA, 94920-2602, US

(73) Assignee: MY-T LLC, Tiburon, CA (US)

(21) Appl. No.: 11/306,070

(22) Filed: Dec. 15, 2005

Related U.S. Application Data
(60) Provisional application No. 60/636,364, filed on Dec. 15, 2004.

(51) Int. Cl. G06F 15/173

(52) U.S. Cl. 709/223

(57) ABSTRACT

A communications distribution system for a network, e.g. Internet E-Mail transmitted between interactive display terminals. The invention offers a solution to the above problems by providing a display interface at a receiving terminal including the conventional mechanisms of access of an E-Mail distribution server by an E-Mail client; but in addition provides an indicator mechanism enabling a user of the E-Mail distribution system to receive an indication of its status of the system. The invention further provides, in some implementations, a mechanism to initiate various tests to confirm access and availability. This invention is applicable to enable an E-Mail user to instantly and visually/aurally determine whether any connected E-Mail distribution system is presently available. The invention may also be extended to other communications networks including standard telephone (POTS, PSTN), cellular, and wireless, broadband communications systems.

### BACKGROUND OF THE INVENTION

The present invention generally relates to communications messaging systems, and more particularly to computer-managed communications networks (e.g., the Internet, the World-Wide Web (web), public switched telephone network (PSTN), and cellular telephone networks), and more specifically, the present invention relates to interpersonal messaging systems (e.g., electronic mail (e-mail) and cellphones).

The past decade has been marked by a technological revolution driven by the convergence of the data processing industry with the consumer electronics industry. The effect has, in turn, driven technologies that have been known and available but relatively quiescent over the years. An important one of these technologies is the Internet or Web related distribution of documents. The Web or Internet, which had quietly existed for over a generation as a loose academic and government data distribution facility, reached “critical mass” and commenced a period of phenomenal expansion. With this expansion, businesses and consumers have direct access to all matter of documents and media through the Web, and access to an alternative message delivery system. Also, as a result of the rapid expansion of the Web, E-Mail, which has been distributed for over twenty-five years over smaller private and specific purpose networks, has moved into distribution over the Web because of the vast distribution channels that are available and the ease and portability of use of this type of distribution.

The availability of extensive E-Mail distribution channels has made it possible to keep all necessary parties in business, government and public organizations completely informed of all transactions that they need to know about at almost nominal costs. However, there can be too much of a good thing. The availability of inexpensive E-Mail has led to a proliferation of E-Mail that many executive, management, professional and technical individuals believe is undesirable as they are forced to handle this seemingly unending deluge of messages.

This proliferation is not necessarily detrimental in all instances. Attendant to this proliferation is an increasing reliance upon the availability and access to E-Mail distribution systems because of some of the advantages of e-mail including speed and versatility. As E-Mail distribution systems begin to be used and relied upon for critical, important, or just desirable distributions of information, it becomes increasingly important that the infrastructure be in place and be operational for accessing this information. Unfortunately, current E-Mail distribution systems do not provide users with any direct mechanism to confirm easily whether their desired levels of actual availability and access are present for their e-mail system.

For some users a significant amount of time (and as the information in a E-Mail message or stream of messages becomes important or critical this amount of time that must lapse before it is fact “significant” decreases) may lapse before problems are detected. The awareness of the user may depend upon many factors, including: (i) an average quantity of E-Mail communications received over any given period, (ii) an ability of a user to perceive changes in the received quantity, and (iii) recognition that certain changes in the apparent quantity reduction are an indication of a problem in the availability and access to an E-Mail Distribution system. In some cases, the problem may not be brought to the user's attention until after much later beyond the window of significance. In some cases, an outside agency may use an alternate communication system (e.g., telephone) to contact the user about the problem or in more serious situations, about a failure of the user to respond to an E-Mail message or initiate some action in response to the E-Mail message.

For users who suspect a problem with availability and access, there is no convenient mechanism to verify or quantify the level or degree of availability/unavailability and access (though in many cases the situation is binary—either it “works” or not. However, in some cases a system may partially work for example by (i) accessing internal E-Mail and not accessing external E-mail, (ii) receiving e-mail messages but not sending e-mail messages. A user may send a sample message to another user/account, asking for a return response. The user may request, via a separate communications system, a test message from another user/account. While there are many problems with these troubleshooting activities, significant problems include that the user must be proactive to initiate such tests, and the tests, even at their best, are time-consuming and inconvenient to perform.

Many current E-Mail distribution systems provide routine physical layer checks to a next-in-sequence distribution device of the E-Mail distribution system. For example, most E-Mail distribution clients will notify a user when a network connection/telephone line is unavailable, or when necessary access/login credentials are incorrect. Unfortunately, because of the expanse and decentralization of many functions, pathways, routings, and other components of E-Mail distribution systems, such nearest-neighbor physical layer checks are insufficient to wholly answer whether the user has functional availability and full access to the desired E-Mail distribution system.

There are also systems that may be adapted to assist in troubleshooting E-Mail distribution systems, at least for those knowledgeable and initiative users who invest the necessary time to do this and exert themselves. For example, some systems may permit entry of an E-Mail address for a user (e.g., a return address in a receipt request) such as by initiating transmission of an E-Mail message to a remote process and then causing the remote process to issue an E-Mail test message to the return E-Mail address. Or, a user may telephone another user and request test messages. Because the user does not control precisely the content and timing, some ambiguity is added into the testing so that a failure to receive and/or recognize a received message cannot necessarily indicate a problem. As the user continues to test and request more messages, important time is consumed and otherwise useless messages (the test message) accumulate in the e-mail client that can interfere with locating and responding to non-testing messages.

As stated above, systems like this require a degree of initiative and technical expertise from the user to activate such tests. Further, such systems only inferentially indicate an error, above the immediate physical link layer, upon failure of a return receipt E-Mail message or lack of receipt of an expected message. Further, the proliferation problem noted above makes many users of E-Mail distribution systems reluctant to further increase a volume of received messages in their chosen E-Mail message collection/reading mechanism/process as it continues to degrade and erode non-testing uses.

Thus, conventional procedures are not solutions to the problems described above. It would be beneficial to simply and efficiently solve these problems with the prior art to provide a mechanism that easily verifies and/or validates a desired communications channel, such as an E-Mail delivery system or telecommunications system.

### BRIEF SUMMARY OF THE INVENTION

Preferred embodiments of the present invention provides an electronic mail distribution system for a network, e.g. Internet E-Mail transmitted between interactive display terminals. These embodiments offer a solution to the above problems by providing a display interface at a receiving terminal including the conventional mechanisms of access of an E-Mail distribution server by an E-Mail client; but in addition provides an indicator mechanism enabling a user of the E-Mail distribution system to receive an indication of its status of the system. These embodiments further provide, in some implementations, a mechanism to initiate various tests to confirm access and availability. The present invention is applicable to enable an E-Mail user to instantly and visually/aurally determine whether any connected E-Mail distribution system is presently available.

The embodiments further provide for a display interface at a receiving terminal that includes mechanism enabling a user of a communications system (e.g., E-Mail distribution and telephones (POTS (plain old telephone system)), cellular, and Voice-over-IP (VoIP)) to verify actual access and availability of a communication channel. The embodiments include a heartbeat server agent function for periodically issuing channel verification heartbeat communications over the applicable channel. These communications are, in the preferred embodiment, recognized by the telecommunications device as meta-communication signals and not used in conventional fashion (e.g., not presented in the mailbox or not initiating a “ring” signal) but are used in the establishment of a mode for a status indicator and/or for initiating channel communication verification/troubleshooting activities and providing operational/administrative metrics and functions. However in simple implementations, standard email may function in this capacity, preferably tagged or otherwise recognizable as heartbeat test messages.

While the preferred embodiment provides for a status indicator/verification initiation function to an end-user, in some implementations the channel communications device returns heartbeat signals or heartbeat echo signals to a management function for assisting in a monitoring and troubleshooting of the communications system on behalf of a particular user. In some instances, the testing/monitoring function is provided on a subscription basis for users desiring increased confidence in the access and availability of communications resources. In some implementations a heartbeat server or a heartbeat client may exchange roles or request round-trip or other message exchange protocols. Servers and/or clients using these heartbeats may be integrated into and adapted for various components of the standard communication channel or they may be stand-alone units communicated into the communications network, or some combination. The present invention encompasses implementation in any communications channel, including for example computer networks (wired/wireless), telephone (POTS, PSTN, cellular, VoIP). By using actual emulated messages that are specially tagged, a system tests actual function without actuating the consumer function so that an indicator produces a status indication of the emulated message receipt/consumption without many negative consequences of issuing the emulated messages (e.g., emulated messages do not fill an inbox, they do not “ring” a phone or otherwise perform or implement notification features associated with actual messages).

### BRIEF DESCRIPTION OF THE SEVERAL VIEWS OF THE DRAWING

The present invention will be better understood and its numerous objects and advantages will become more apparent to those skilled in the art by reference to the following drawings, in conjunction with the accompanying specification, in which:

FIG. 1 is a schematic view of a computer network, implementing a preferred embodiment of the present invention;

FIG. 2 schematically illustrates the main components of a generic computer of the network shown in FIG. 1;

FIG. 3 is a second generalized view of an E-Mail distribution system in a network environment that may be used in the practice of the present invention;

FIG. 4 is a representation of one example of an interface element for a client;

FIG. 5 illustrates an “OK STATUS” indicator;

FIG. 6 illustrates a “FAIL STATUS” indicator;

FIG. 7 illustrates an “UNKNOWN STATUS” indicator;

FIG. 8 is a generalized view of an E-Mail Channel distribution and verification system in a network environment implementing a preferred embodiment of the present invention;

FIG. 9 is an interface element depicting but one example of a possible set of configuration options for a preferred embodiment of the present invention; and

FIG. 10 is a generalized view of a telecommunications channel calling and verification system in a network environment implementing a second preferred embodiment of the present invention.

### DETAILED DESCRIPTION OF THE INVENTION

The present invention relates to an efficient communications channel verification solution that provides a user with simple and quick confirmation of the actual availability of communications across a plurality of locations, and one that may be easily used without complicated or time-consuming configuration options. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein. As the present invention is applicable to many different types of communications systems, the following description simplifies explanation by explaining the invention in terms of e-mail distribution systems and telephone networks. The invention may be simply adapted and extended for other communications systems.

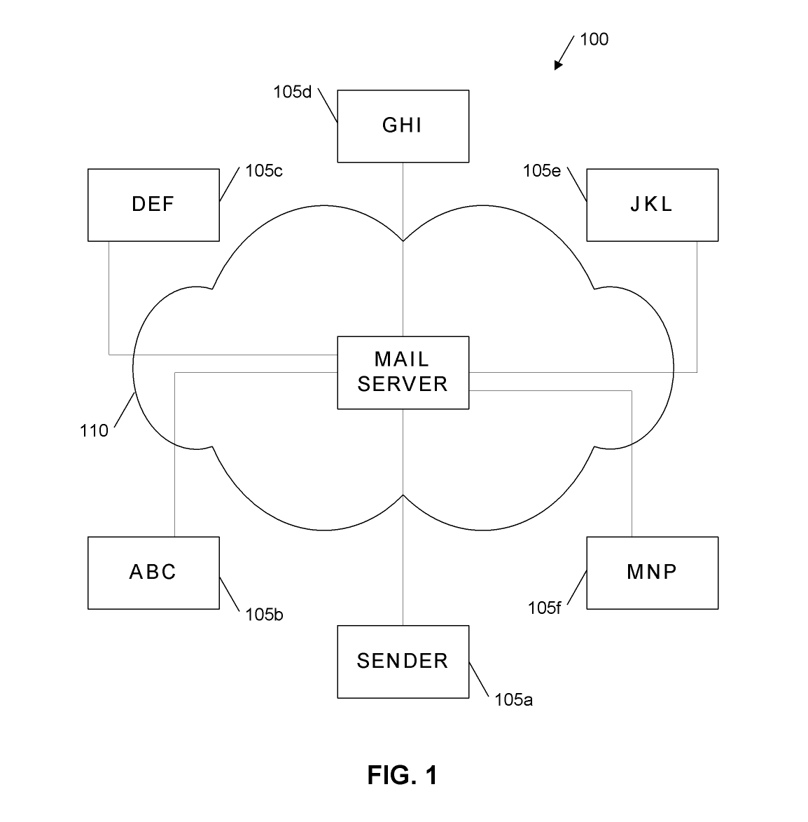

With reference to the drawings, in FIG. 1 a distributed data processing system or computer network 100 is schematically shown. The computer network 100 may be for example a local area network (LAN), a metropolitan area network (MAN), a wide area network (WAN) or a network of networks such as the Internet, and comprises a plurality of computers 105a-105f interconnected to each other by means of a data communication infrastructure 110.

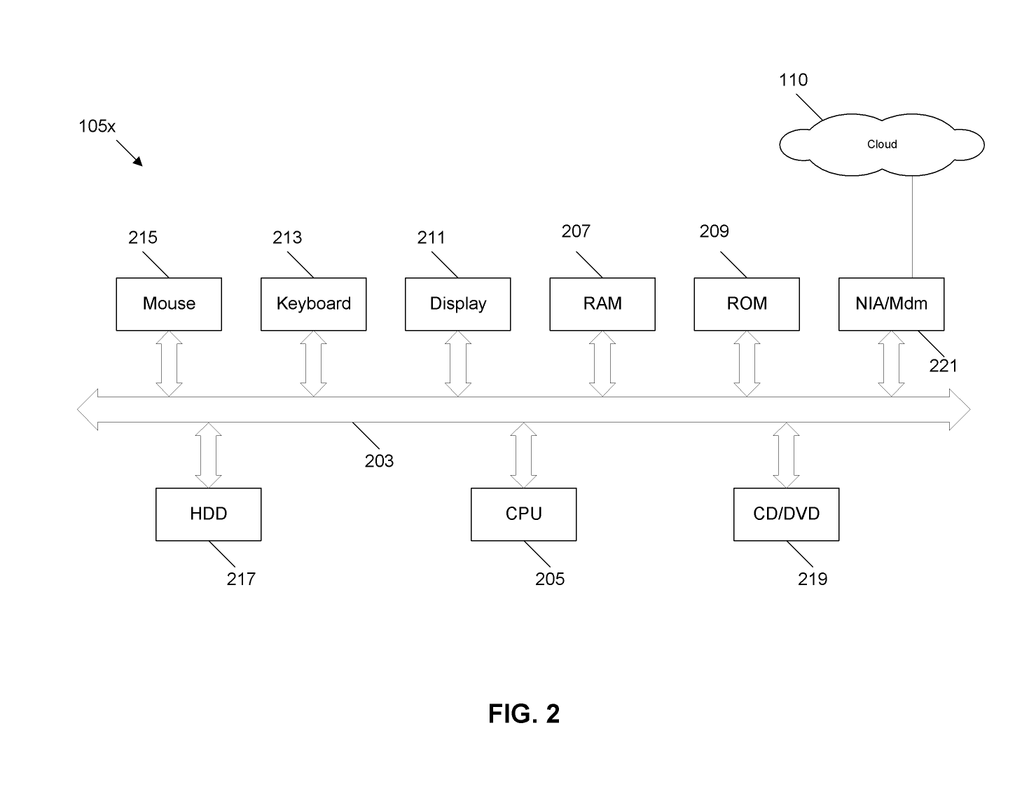

As schematically shown in FIG. 2, a generic computer of the computer network 100, e.g. the computer 105a, includes several functional units connected in parallel to a data communication bus 203, for example of the PCI type. In particular, a Central Processing Unit (CPU) 205, typically comprising a microprocessor, controls the operation of the computer 105a, a working memory 207, typically a RAM (Random Access Memory) is directly exploited by the CPU 205 for the execution of programs and for temporary storage of data, and a Read Only Memory (ROM) 209 stores a basic program for the bootstrap of the computer 105a. The computer 105a comprises several peripheral units, connected to the bus 203 by means of respective interfaces. Particularly, the peripheral units that allow the interaction with a human user are provided, such as a display device 211 (for example a CRT, an LCD or a plasma monitor), a keyboard 213 and a pointing device 215 (for example a mouse or a trackpoint). The computer 105a also includes peripheral units for local mass-storage of programs (operating system, application programs) and data, such as one or more magnetic Hard-Disk Drivers (HDD), globally indicated as 217, driving magnetic hard disks, and a CD-ROM/DVD driver 219, or a CD-ROM/DVD juke-box, for reading/writing CD-ROMs/DVDs. Other peripheral units may be present, such as a floppy-disk driver for reading/writing floppy disks, a memory card reader for reading/writing memory cards and the like. The computer 105a is further equipped with a Network Interface Adapter (NIA) card 221 for the connection to the data communication network 110; alternatively, the computer 105a may be connected to the data communication network 110 by means of a MODEM.

Any other computer 105b, . . . , 105f in the computer network 100 has a structure generally similar to that depicted in FIG. 2, possibly properly scaled depending on the machine computing performance.

The computer network 100 supports an electronic mail (shortly, e-mail) service, enabling users of the computers 105a-105f to exchange e-mail messages. The details of the e-mail service are known per-se and will not be described in depth. Different e-mail addresses identify different users who are subscriber to the e-mail service; by way of example, in the following it will be assumed that e-mail service is an Internet e-mail service, in which an e-mail address takes the form user@host.domain, and that the users ABC, DEF, GHI, JKL, MNP of the computers 105b to 105f have respective e-mail addresses abc@xy.com, def@xy.com, ghi@zw.com, jkl@zw.com, mnp@qr.net.

One or more computers 115 in the computer network 100 act as e-mail server computers (shortly, mail servers), also known as mail transfer agent, managing the distribution of e-mail messages coming from different users to the intended recipients. When a user desires to take advantage of the e-mail service, he/she has to preliminary subscribe for this service at a mail server; an e-mail account is opened at the mail server for the new subscriber, an e-mail address is assigned thereto, and a mailbox is created. Typically, e-mail messages addressed to a given e-mail address are stored in the mailbox of the mail server holding the corresponding account, until the subscriber user connects to the mail server and downloads the messages from the mailbox. Similarly, when a subscriber user desires to send an e-mail message to one or more other subscribers, the user composes the e-mail message and sends the message to the respective mail server, which then delivers the message to the recipients, according to the e-mail addresses specified in the message (as will be described later on).

When, for example, the user of a computer 105a (the sender) intends to send an e-mail message to one or more of the users of the computers 105b-105f (the recipients ABC, DEF, GHI, JKL, MNP), the computer 105a sends the message to the respective mail server 115; based on the e-mail addresses of the message recipients, the mail server 115 then delivers the e-mail message to the proper mail servers of the intended recipients. Each mail server holds, for each of the respective subscriber users, a mailbox of incoming e-mail messages; by connecting to the mail server, the user downloads the messages in the respective mailbox, though sometimes the mailbox is included on a local computer system or other times on a remote computer system.

In order to interact with the respective mail server, in each of the computers 105a-105f an e-mail client software is installed. The e-mail client software, when running on a computer, acts as a mail user agent, which interacts with the mail transfer agent. The e-mail client software is invoked whenever the user of the computer desires to send an e-mail message or to connect to the respective mail server, so as to download and display the e-mail messages addressed to the e-mail consumer.

Before going further into the details of specific embodiments, it will be helpful to understand from a more general perspective the various elements and methods that may be related to the present invention. Since a major aspect of the present invention is directed to systems for the transmission of E-Mail documents over networks, an understanding of networks and their operating principles would be helpful. This description does not go into great detail in describing the networks to which the present invention is applicable. Reference has also been made to the applicability of the present invention to a global network, such as the Internet or Web. For details on Internet nodes, objects and links, reference is made to the text, Mastering the Internet, G. H. Cady et al., published by Sybex Inc., Alameda, Calif., 1996. The Internet or Web is a global network of a heterogeneous mix of computer technologies and operating systems. Higher level objects are linked to the lower level objects in the hierarchy through a variety of network server computers. E-Mail is distributed through such a network. Operating systems may directly support e-mail functions, or directly support applications/processes that directly support e-mail functions (e.g., a dedicated e-mail client like Qualcomm's Eudora or Microsoft's Outlook, or may support e-mail clients embedded in other applications like a Web Browser. In some instances e-mail messages are received locally and in others a local client/process is a viewer into a remote client that holds and stores e-mail messages. Some or all of these components may be on a local computer system, a local network or other remote networks or on the Internet or Web. Also, the present invention distinguishes between a mail_client and a user and a consumer. These are different functions that may be combined together in different configurations or numbers. A single user may operate multiple mail_clients for one or more sets of e-mail messages. In some cases, mail_clients may exist with a specifically identified user or consumer, or the user may be a virtual user or administrative/management process that processes e-mail messages without direct human interaction.

The following few paragraphs provide a basic overview of some of the components and functionality of an e-mail delivery system in one possible arrangement and configuration: E-mail (electronic mail) includes an exchange of computer-stored messages by telecommunication. (Sometimes it is referred to as email; the following discussion uses e-mail.) E-mail messages are usually encoded in ASCII text. However, a user may also send non-text files, such as graphic images and sound files, as attachments sent in binary streams. E-mail was one of the first uses of the Internet and is still the most popular use. A large percentage of the total traffic over the Internet is e-mail. E-mail can also be exchanged between online service provider users and in networks other than the Internet, both public and private. E-mail may be distributed to lists of people as well as to individuals. A shared distribution list may be managed by using an e-mail reflector. Some mailing lists allow you to subscribe by sending a request to the mailing list administrator. A mailing list that is administered automatically is called a list server. E-mail is one of the protocols included with the Transport Control Protocol/Internet Protocol (TCP/IP) suite of protocols. A popular protocol for sending e-mail is Simple Mail Transfer Protocol and a popular protocol for receiving it is POP3. Both Netscape and Microsoft, among other manufacturers, include an e-mail utility within their Web browsers.

Billions of electronic mail (e-mail) messages move across the Internet every year. Sending electronic letters, pictures and data files, either across a building or across the globe, has grown so popular that it has started to replace some postal mail and telephone calls. This universal medium is no longer restricted to exchange of simple text messages and is now regularly used to deliver voice mail, facsimiles and documents that may include images, sound and video. Typically, a message becomes available to the recipient within seconds after it is sent-one reason why Internet mail has transformed the way that we are able to communicate.

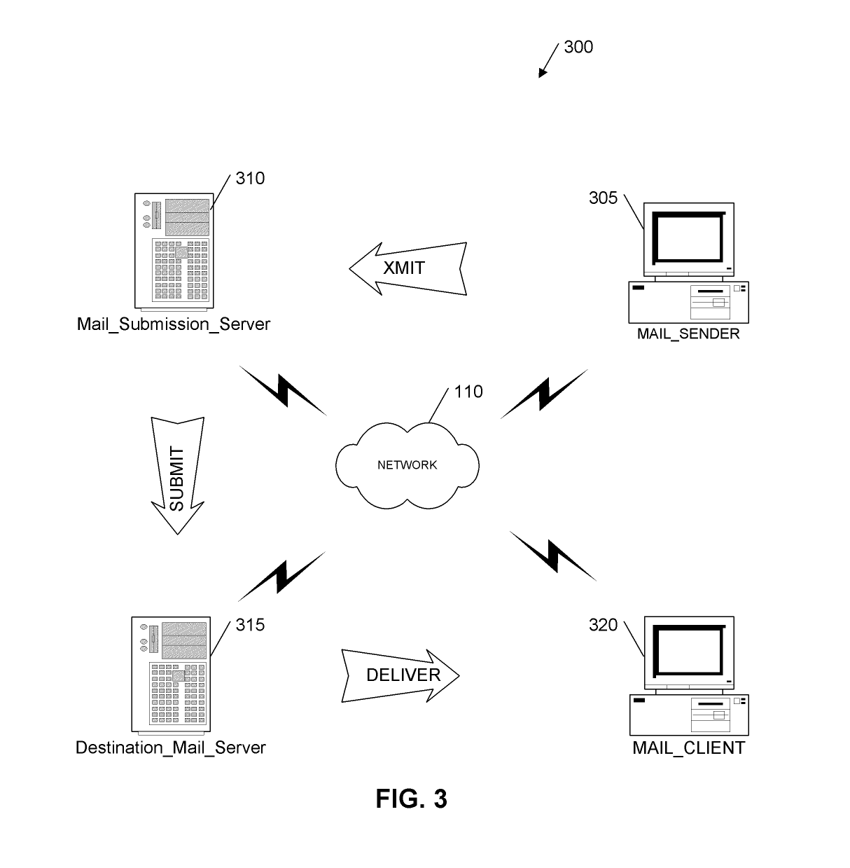

FIG. 3 is a second generalized view of an E-Mail distribution system 300 in a network environment that may be used in the practice of the present invention.

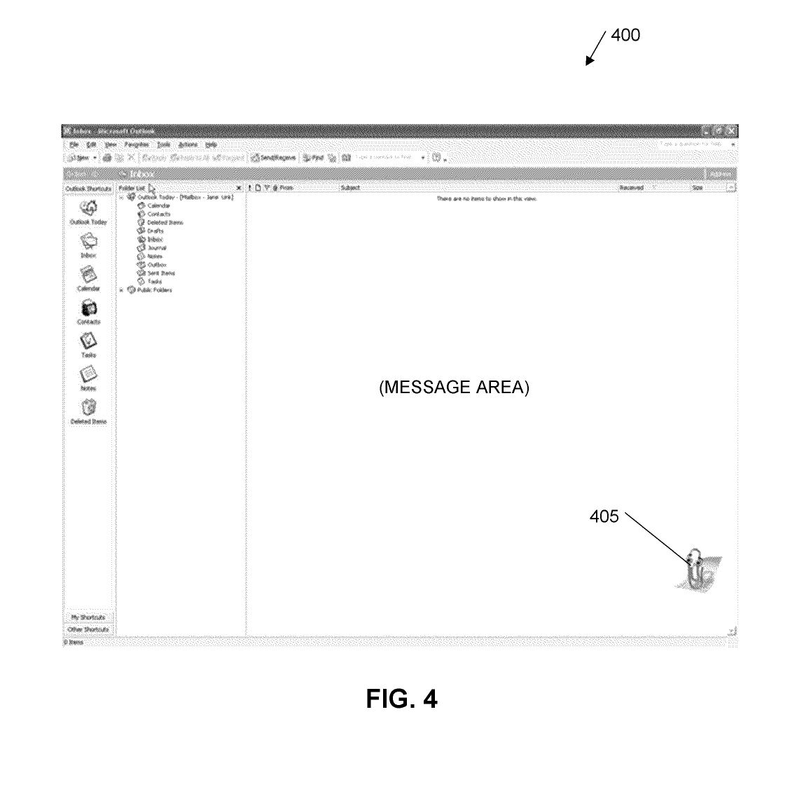

1. A MESSAGE SENDER 305 uses mail software, called a client, to compose a document, possibly including attachments such as tables, photographs or even a voice or video recording. FIG. 4 is a representation of one example of an interface element for a client 400 (in this case client 400 is represented by an e-mail client interface available in Microsoft's Outlook client). System software, called Transmission Control Protocol (TCP), divides the message into packets and adds information about how each packet should be handled-for instance, in what order packets were transmitted from the sender. Packets are sent to a mail submission server 310, a computer on the internal network of a company or an Internet service provider for example.

2. INTERNET MAIL ADDRESSES, as discussed above, attached to each message are in the form “mailbox@domainname”—one specific example being “webmaster@corp.com.” The multipart domain name in the above example denotes a top-level domain (“.com”) following the second-level domain (“corp”). A message is delivered to an individual or a group by the mailbox name (“webmaster”).

3. MAIL SUBMISSION SERVER 310 converts the domain name of the recipient's mail address into a numeric Internet Protocol (IP) address. Querying domain name servers (not shown) interspersed throughout the network/Internet does this conversion. For example, the mail submission server may first request from the “root” name server the whereabouts of other servers that store information about “.com” domains (a). It then interrogates the “.com” name server for the location of the specific “sciam.com” name server (b). A request to the “sciam.com” name server provides the IP address for the computer that receives the mail for sciam.com, which is then attached to each message packet (c).

4. ROUTERS (also not shown) dispersed throughout the Internet read the IP address on a packet and relay it toward its destination by the most efficient path. (Because of fluctuating traffic over data lines, trying to transmit a packet directly to its destination is not always the fastest way.) The packets of a single message may travel along different routes, shuttling through ten or so routers before their journey's end.

5. A DESTINATION MAIL SERVER 315 places the packets in their original order, according to the instructions contained in each packet, and stores the message in the recipient's mailbox. A mail client 320 (e.g., client 400) may then acquire/access and display the message. The software used by the mail_sender and the mail_client may be the same, similar, or drastically different. For purposes of the following discussion, the MAIL_CLIENT is shown in FIG. 4 in which received messages are listed (sometimes with a preview or thumbnail) in the message area. Other times, the message area includes lists of messages to be acted upon. Client 400 actually is a close representation of an interface element of Microsoft Outlook that includes a representative “Assistant” icon 405 that initiates a help system for Outlook. In the present invention, icon 405 also represents an indicator or feedback system 405 for visually indicating a condition of the user's e-mail system. One implementation provides for icon 405 to reflect a status condition as follows.

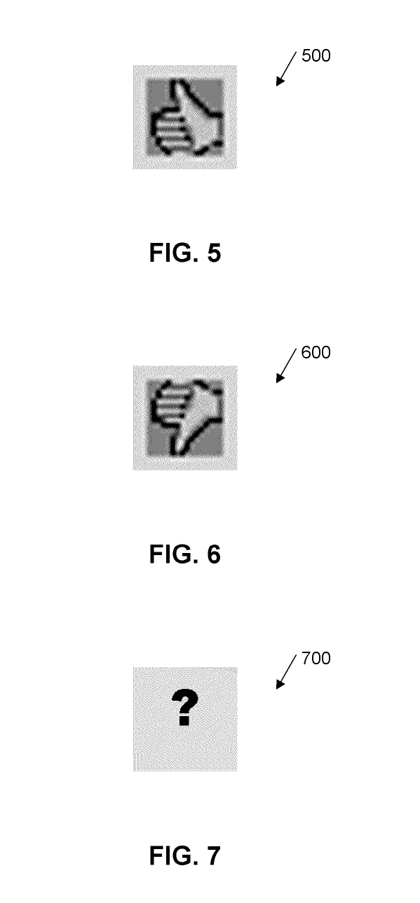

FIG. 5-FIG. 7 are representative status indication icons that may be used in conjunction with icon 405, for example. FIG. 5 illustrates an “OK STATUS” indicator 500, FIG. 6 illustrates a “FAIL STATUS” indicator 600, and FIG. 7 illustrates an “UNKNOWN STATUS” indicator 700 used when the embodiment has yet to determine whether to use indicator 500 or indicator 600. Indicator 500-indicator 700 may be used as part of icon 405, or integrated into a toolbar or other structure of client 400 or messaging feature, or in a structure of the operating system or other application/process supported by the operating system. For example, Windows XP, like many other versions of Windows, includes an application bar and status tray in which various functions, features, and status indicators are presented to a user to monitor applications and processes on a computer system. The indicators may be presented, as appropriate, in this system tray area of the operating system. While the indicators described above are shown as visual indication elements, other indication systems may also be used in cooperation or in lieu of (including aural cues to present status information to the user). Different users are able to customize various thresholds associated with the various indicators as described further below.

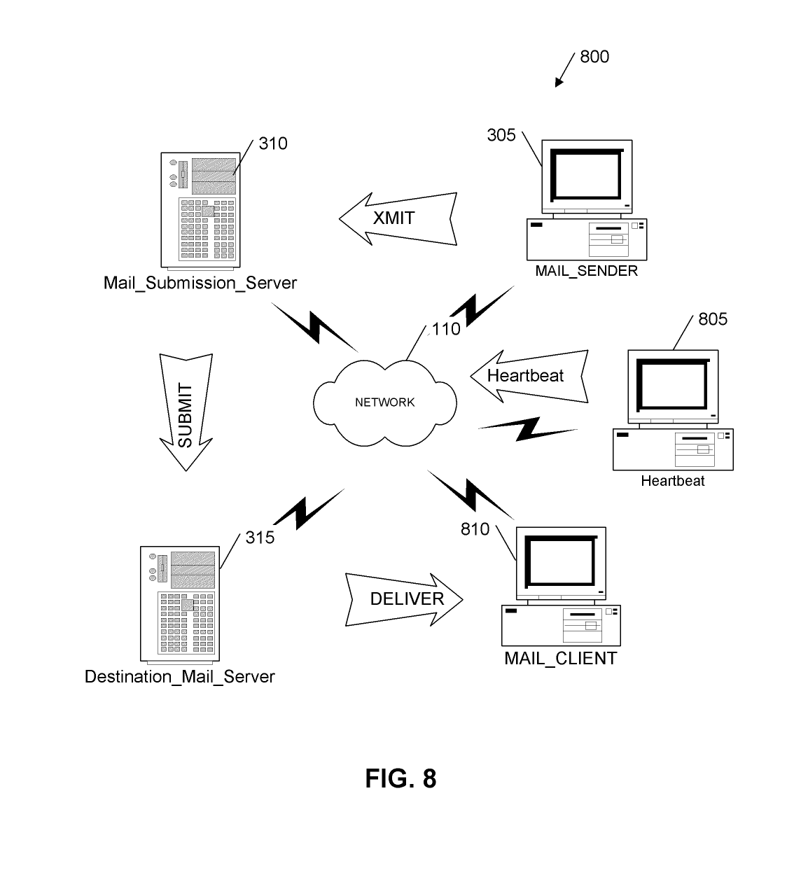

FIG. 8 is a generalized view of an E-Mail Channel distribution and verification system 800 in a network environment implementing a preferred embodiment of the present invention. Similar to system 300 shown in FIG. 3, system 800 operates to exchange e-mail messages in conventional fashion. In addition to the components and functions described in cooperation with the elements of system 300, system 800 includes a heartbeat server 805. Heartbeat server 805 periodically issues predetermined e-mail-like messages (referred to herein as heartbeats) specially destined for a heartbeat-enabled MAIL_CLIENT 810. Depending upon whether predetermined thresholds are satisfied (as determined by server 805 and/or client 810) generator 805 and/or client 810 may each independently or cooperatively determine that one or more components of system 800 are not working. Server 805 may, in some configurations, also receive heartbeats from other servers or clients and it may receive other communications including echo_heartbeats.

As discussed above, system 300 may fail to deliver messages from sender 305 to client 320—(Note it is typical during 2-way communications for a computer system (e.g., 305) to switch roles and take on another function (e.g., become a “client” rather than a sender). It is possible for a system 300 to work in one configuration and not work in the “reversed” direction due to different pathways and configuration elements. System 800 provides a user with an ability to determine whether either or both “directions” are actually functioning.

Many clients 320 have an ability to detect very simple failures. For example, when a physical link is absent (a missing network cable or no dial tone for example), many clients provide feedback that a connection is not possible. However, a capability of one component of system 300 to establish a basic physical connection to its next-nearest neighbors does not guarantee that messages may be properly delivered or that the entirety of system 300 is operational. Part of the difficulty is that system 300 is replicated for millions to billions of connections and each pathway from a sender to a receiver may define a unique system 300 as to any pair of senders and receivers. Often a single set of machines support these myriad “virtual” systems 300 and as between many pairs passing through the same physical system, each may have a different operational status. Sometimes the variations are dependent upon individual configurations, sometimes on local (e.g., on a component or element a receiver may directly physically access) and sometimes it may be remote (non-local). Whatever the reasons may be, it is the case that the physical structures may all appear to be operating normally yet e-mail message are unable to propagate as described above from a sender to the client. Users have different tolerances for e-mail disruption and system 800 permits users having critical need of their e-mail system 800 to be kept apprised as frequently as necessary regarding the then-current status of an ability of system 800 to actually deliver an e-mail message.

System 800 does this by sending client 810 a periodic heartbeat through the e-mail components. The heartbeat, being sufficiently e-mail-like, propagates just like an e-mail message would and success or failure of the heartbeat reflects the likelihood that real e-mail messages will be able to propagate to client 810. A key difference between heartbeats of the present invention and actual e-mail messages is that client 810 recognizes these as heartbeats and does not present them to the user for review, the message area does not fill up with these messages, client 810 may immediately discard these heartbeats without user intervention so that resources of the user are not used and it does not interfere with the operation of system 800 in presenting real e-mail messages. (Of course in some embodiments, some users may desire or accept heartbeats that are actual recorded messages in the user's “inbox”—such as when the heartbeats include performance metrics for user review—but that is not preferred). In a simple embodiment, a heartbeat may be a special e-mail message tagged by a specific sender address, subject, and/or message content so that it actually accurately emulates an e-mail message yet client 810 may automatically discard it without putting it in the inbox (or even into a “discard” or “garbage” subfolder of the inbox.)

Thus, system 800 continuously and reproducibly issues these heartbeat signals destined for client 810 on a predetermined schedule. As long as heartbeats are received as scheduled, client 810 actuates indicator 500 to indicate system 800 is working properly. When a failure condition is detected, client 810 actuates indicator 600 to apprise the user of a failure in the communication channel. Until client establishes the condition of system 800, indicator 700 is actuated.

As noted above, sender and client roles are reversible in system 300 and system 800 supports this as well. In the case of monitoring for or detecting faults with an ability of client 810 to actually send e-mails out to a sender 305, client 810 may be enabled to generate heartbeats and to send them to heartbeat server 805 on a predetermined schedule. As long as heartbeats generated by client 810 arrive at server 805 as scheduled, server 805 establishes that e-mails transmissions for client 810 (send mail) are viable. However, in the event of a failure, server 805 may be able to communicate the failure directly to client 810 (as noted above, failures may in some circumstances be asymmetric) or server 805 may need to use an alternate communication channel (e.g., fax, pager, phone line, alternate e-mail address or the like) to notify a user or a user agent.

Depending upon implementations and needs of users or administrators of system 800, many different combinations or features may be made. For example, heartbeats may contain timing/routing/propagation data or other information that could be important to a user, administrator, or client 810 and these data or information may be monitored for performance related information beyond simply establishing whether minimal performance levels. Additionally, server 805 and client 810 may maintain a dialog with each other that monitor the other and passes status or other metric information between them to collectively establish a health and status of various features of system 800. For example, at various times (or periodically) server 805 may generate a special action_heartbeat to client 810 to initiate some particular function (like a return heartbeat of a certain type that is referred to herein as an echo_heartbeat). Or, client 810 may do the same. Depending upon the response, if any, various conditions of system 800 may be revealed to one or both of server 805 and client 810. As appropriate, these components individually react or provide indications/notifications depending upon configuration information. In some systems, placing servers 805 at various locations in a distributed network, an accurate “map” may be developed through monitoring where and which heartbeats are generated and actually consumed by the various components. Associating servers 805 with various network segments and/or network components gives a direct feedback when heartbeats from those servers are detected/consumed by a client (which may also be distributed throughout the communications network).

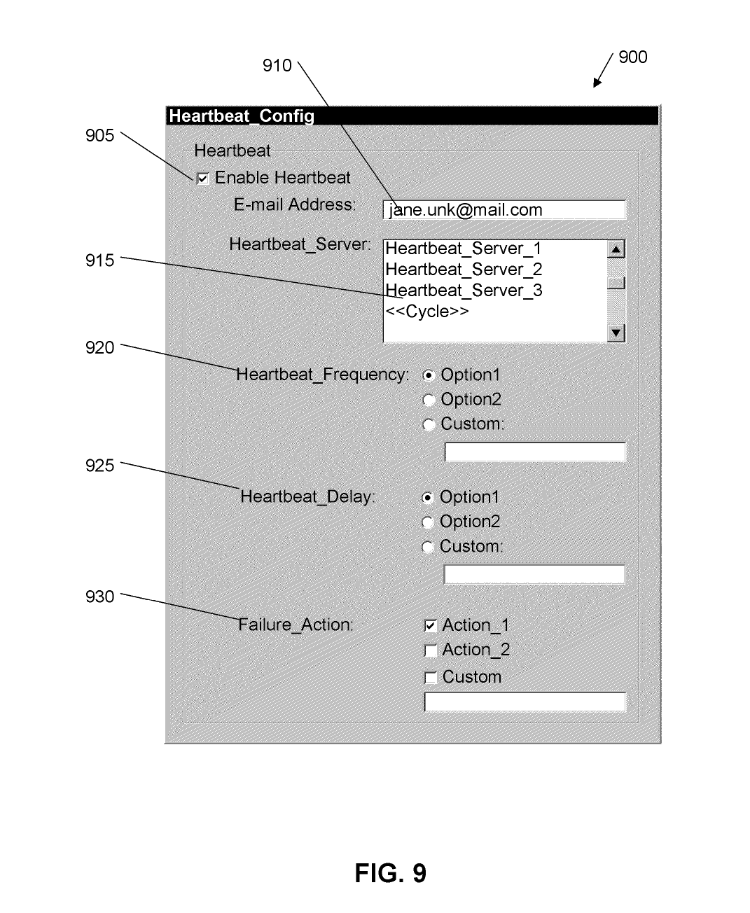

FIG. 9 is an interface element 900 depicting but one example of a possible set of configuration options for a preferred embodiment of the present invention. Interface element 900 is associated with client 810 and permits a user to customize client 810 insofar as its response and handling of heartbeats is concerned. A first option 905 enables/disables heartbeats for client 810. When enabled, interface 900 exposes/activates the other options as shown in FIG. 9. Interface 900 includes an address field to designate an e-mail address to which server 805 is to send heartbeats. Interface 900 provides the user with an ability to access a particular heartbeat server 805 to use in sending the heartbeats. Sometimes geographic location or specific backbone connections may affect e-mail system 800 negatively or be required to better duplicate any given user's e-mail delivery system so system 800 may include heartbeat servers 805 in different representative locations and/or on different physical backbones. A user may select one or more servers or request that all the servers be used (e.g., cyclically). Heartbeat server listbox 915 includes the available heartbeat servers/options. A first option set 920 provides the user with an ability to set a frequency of heartbeat generation (e.g., by server 805). Some standard options are provided and in some cases a user may be provided the ability to enter in a desired frequency. For example, option 1 may be one heartbeat per fifteen minutes, and option 2 may be one heartbeat per five minutes. A related second option set 925 provides the user with an ability to set a threshold for an amount of delay before an error condition is satisfied. For example, when first option set 920 indicates a heartbeat should be received at least one every fifteen minutes and more than fifteen minutes have elapsed since the last heartbeat, the value selected in option set two 925 establishes whether and to what degree late heartbeats are in fact considered late and therefore warrant actuation of indicator 600. Third option set 930 provides the user with some options to handle a heartbeat failure condition. Action 1 may include an audio/visual indicator, Action 2 may include actuation of an alternate communication channel to the user (e.g., e-mail may be broadband based so Action 2 may initiate a telephone call to a pager hotline.) The actions of option set 3 may be combined and used cooperatively, with a user choosing to have both an audio/visual indicator and actuation of an alternate communication channel message. The various parameters and values of the different option sets are established based upon a particular embodiment and implementation appropriate for the needs of the users, administrators and system 800 configuration details. In some instances, client 810 may have an automatic diagnostic mode (such as during a failure) in which specific diagnostics are activated. For example, when multiple servers 805 are strategically located throughout the network, client 810 may be able to cycle through them methodically to isolate and report where a problem resides. The use of a server 805 and client 810, particularly those that are able to generate echo_heartbeats provides an ability to do loopback testing of the communications network.

Interface 900 is described as associated with client 810 (which is the preferred embodiment for a single-user setup). In some cases, a network administrator may set up server 805 for many users and in which case interface 900 may be associated with server 805. Server 805 and client 810 may exchange various configuration information parameters to function effectively together. Also, the above description includes use of specifically addressed heartbeats (rather than generic “broadcast” heartbeats). In some instances, it may be appropriate and advantageous (for example in a LAN environment) to use broadcast heartbeats when such broadcast heartbeats may effectively provide similar functionality. By broadcast heartbeats, it is taken to mean that the heartbeat or the clients are configured or have their addresses masked in a way that multiple clients may react/respond to a single heartbeat.

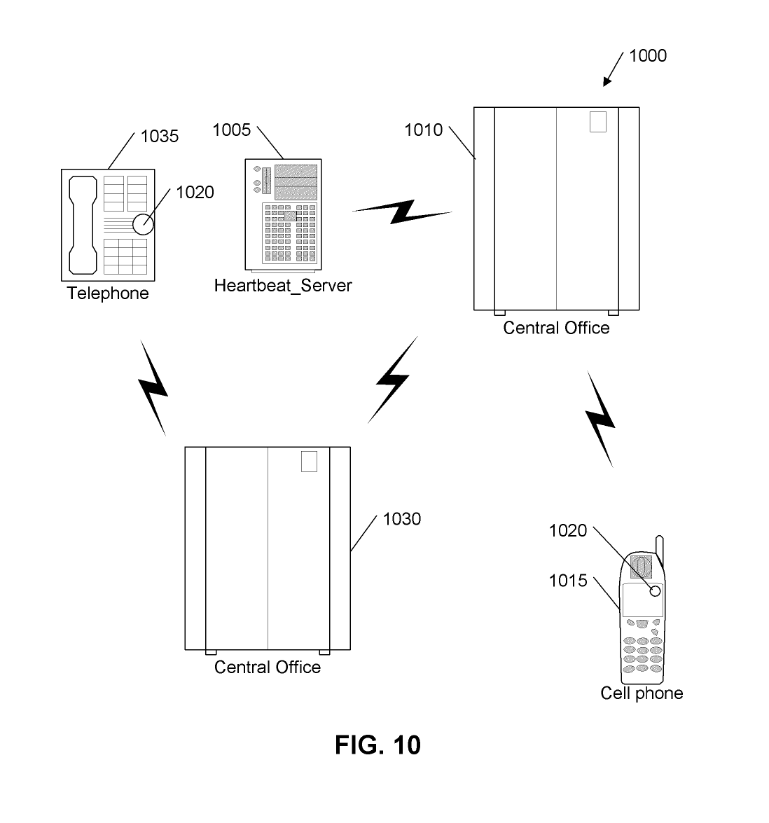

FIG. 10 is a generalized view of a telecommunications channel calling and verification system 1000 in a network environment implementing a second preferred embodiment of the present invention. System 1000 provides an ability for a user of portable communications device (e.g., a cellular telephone, pager, personal digital assistant (PDA) and the like to also verify actual operation of a particular device. Just like in the example described above, portable communications devices often have a mechanism to determine whether certain minimal conditions are present (e.g., whether a sufficiently strong signal from a local cellular tower is detected) but not whether in fact communication events may in fact be exchanged with the communications medium. Thus, by extension from system 800, system 1000 includes a heartbeat server 1005 to periodically generate appropriate heartbeats suitable for the communication medium and communications device client. System 1000 also includes a communications station 1010 in a central office that communicates to a portable client 1015 using existing infrastructure. As long as client 1015 receives appropriate heartbeats, an indicator 1020 apprises a user of the status of communications network 1000. In this case, for client 1015 included in a cellular telephone, heartbeats are emulated phonecalls that do not cause the phone to “ring” but the presence of the heartbeat causes indicator 1020 to glow green (for example). Failure of the emulated call within the appropriate conditions causes indicator 1020 to glow red and indicator glows yellow for uncertain conditions. Just as described above, a user may potentially be communication with a local physical nearest-neighbor in the link, but beyond that link the system is not functioning and the user is unable to use the communications channel. Of course, other indication systems may be used in addition to or in lieu of the described green/red/yellow visual indicator.

System 1000 also includes a second central office communications device 1030 for relaying communications events to a telephone 1035 associated with a single physical location (e.g., a landline). Telephone 1035 is also provided with indicator 1020 so that a use may have a visible indication that the landline is actually enabled. As opposed to portable communications devices like cellular telephones, landlines are not equipped with standard with signal strength meters. A user of a conventional phone has no way of knowing, except for picking up a handset, as to whether the phone line is actually functioning. In such a case, indicator 1020 may also function as an external indicator to inform a user whether a dial tone is present by glowing green in response to periodic off-hook events when the dialtone is present. Users may thus be apprised of a potential problem in advance of picking up the telephone to make a call. This is in addition to or as an alternative to controlling indicator 1020 in cooperation with telephone 1035 as described above in cooperation with portable client 1015.

While basic concepts such as heartbeats and loopback have been available in network architectures for some time, these are often physical layer or link layer tests only or they are broadcast signals and not specifically checking whether a specific network component is present and functioning. In some cases, similar diagnostics may be able to be manually initiated but as noted above, a user either must be unduly proactive and periodically test a network or must develop a perception that “something” is wrong. The present invention provides a constant heartbeat (e.g., a steady stream of heartbeat signals issued according to desired parameters) to these communications clients to provide proactive problem detection without drawback to any single client. A user does not need to wonder whether a lack of any messages for some duration is an indication of a problem and the user does not have to process and sift through heartbeat messages overflowing in the user's inbox.

Although embodiments of the invention have been described primarily with respect to communications channels implemented using familiar communications systems like computer networks and telephone networks, many types of communications systems may benefit from features of the present invention. Providing a user with direct feedback of the availability of operational readiness of an electronic device beyond signaling availability of a reduced condition improve user experiences and satisfaction. Additionally, the present invention has been described as being incorporated directly into an E-Mail client. However in some embodiments, heartbeater systems may be provided as a stand-alone system. When implemented on an account holder's computer (stand-alone or integrated versions for example) the heartbeat tests test end-to-end connectivity directly. However parts of the heartbeater may be implemented on a third-party system to test major components of an e-mail configuration remotely. In some implementations, the heartbeater system may be configured to relay tests through another computing system to verify/measure/report complete end-to-end operation.

The system, method, computer program product, and propagated signal described in this application may, of course, be embodied in hardware; e.g., within or coupled to a Central Processing Unit (“CPU”), microprocessor, microcontroller, System on Chip (“SOC”), or any other programmable device. Additionally, the system, method, computer program product, and propagated signal may be embodied in software (e.g., computer readable code, program code, instructions and/or data disposed in any form, such as source, object or machine language) disposed, for example, in a computer usable (e.g., readable) medium configured to store the software. Such software enables the function, fabrication, modeling, simulation, description and/or testing of the apparatus and processes described herein. For example, this can be accomplished through the use of general programming languages (e.g., C, C++), GDSII databases, hardware description languages (HDL) including Verilog HDL, VHDL, AHDL (Altera HDL) and so on, or other available programs, databases, nanoprocessing, and/or circuit (i.e., schematic) capture tools. Such software can be disposed in any known computer usable medium including semiconductor, magnetic disk, optical disc (e.g., CD-ROM, DVD-ROM, etc.) and as a computer data signal embodied in a computer usable (e.g., readable) transmission medium (e.g., carrier wave or any other medium including digital, optical, or analog-based medium). As such, the software can be transmitted over communication networks including the Internet and intranets. A system, method, computer program product, and propagated signal embodied in software may be included in a semiconductor intellectual property core (e.g., embodied in HDL) and transformed to hardware in the production of integrated circuits. Additionally, a system, method, computer program product, and propagated signal as described herein may be embodied as a combination of hardware and software.

One of the preferred implementations of the present invention, for example for the switching control, is as a routine in an operating system made up of programming steps or instructions resident in a memory of a computing system during computer operations. Until required by the computer system, the program instructions may be stored in another readable medium, e.g. in a disk drive, or in a removable memory, such as an optical disk for use in a CD ROM computer input or in a floppy disk for use in a floppy disk drive computer input. Further, the program instructions may be stored in the memory of another computer prior to use in the system of the present invention and transmitted over a LAN or a WAN, such as the Internet, when required by the user of the present invention. One skilled in the art should appreciate that the processes controlling the present invention are capable of being distributed in the form of computer readable media in a variety of forms.

Any suitable programming language can be used to implement the routines of the present invention including C, C++, Java, assembly language, etc. Different programming techniques can be employed such as procedural or object oriented. The routines can execute on a single processing device or multiple processors. Although the steps, operations or computations may be presented in a specific order, this order may be changed in different embodiments. In some embodiments, multiple steps shown as sequential in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “computer-readable medium” for purposes of embodiments of the present invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment”, “an embodiment”, “a preferred embodiment” or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of the present invention can be achieved by any means as is known in the art. Distributed, or networked systems, components and circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims. Therefore the scope of the invention is to be determined solely by the appended claims.

What is claimed as new and desired to be protected by Letters Patent of the United States is:

1. In a communication network with user access via a plurality of communications devices, a distribution system for communications transmitted between the devices comprising: a distributor for issuing a periodic heartbeat communication using the communications network; and an interface coupled to a receiving device, said interface including an indicator and an indicator controller for controlling said indicator responsive to said heartbeat communication without activating said receiving device to receive said heartbeat communication except as used by said indicator controller.

2. The communication network of claim 1 wherein said receiving device is an E-Mail client.

3. The communication network of claim 2 wherein said interface is included as part of said E-Mail client.

4. The communication network of claim 2 wherein said interface is included as part of a computing system supporting said E-Mail client.

5. The communication network of claim 1 wherein said indicator is responsive to a receipt of one of said periodic heartbeat communications within a prespecified period after receipt of a preceding one of said heartbeat communications.

6. The communication network of claim 1 wherein said indicator is responsive to a nonreceipt of one of said periodic heartbeat communications within a prespecified period after receipt of a preceding one of said heartbeat communications.

7. The communication network of claim 2 wherein said periodic heartbeat communications are not directly available to a user through said E-Mail client.

8. The communication network of claim 1 including a non-receipt controller for initiating a non-receipt process responsive to non-receipt of one of said periodic heartbeat communication.

9. The communication network of claim 8 wherein said non-receipt process includes a notification using an alternate message distribution system.

10. The communication network of claim 1 wherein said distribution system is a public switched telephone network (PSTN).

11. The communication network of claim 10 wherein said receiving device is a plain old telephone service (POTS)-compliant receiver.

12. The communication network of claim 10 wherein said heartbeat communication does not activate a ringer of a receiving device.

13. The communication network of claim 10 wherein said indicator is an illumination system

14. The communication network of claim 1 wherein said distribution system is a cellular telephone network.

15. The communication network of claim 14 wherein said receiving device is cellular-network compatible receiver.

16. The communication network of claim 15 wherein said heartbeat communication does not activate an incoming call notification system of the receiver.

17. The communication network of claim 14 wherein said indicator is an element of a display of said receiver.

18. The communication network of claim 1 wherein said indicator includes a “go” indication mode and a “no go” indication mode.

19. In an distribution network with user access via a plurality of communication devices, a distribution method for communications transmitted between said devices, the method comprising: distributing periodic heartbeat communications; and responding to said periodic heartbeat communications to provide an indication of a receipt status of said heartbeat communications without activating said receiver except as used to control a heartbeat indicator.

20. A computer program having code recorded on a computer readable medium for distribution of communications in a distribution network with user access via a plurality of communications devices, said computer program comprising code implementing a communications distribution method, the method comprising: distributing periodic heartbeat communications; and responding to said periodic heartbeat communications to provide an indication of a receipt status of said heartbeat communications without activating said receiver except as used to control a heartbeat indicator.
